(19) United States
(12) Patent Application Publication
(10) Pub. No.: US 2004/0222320 A1
(43) Pub. Date: Nov. 11, 2004

(54) WATER SPRAYER HAVING A FLOW CONTROL DEVICE

(76) Inventor: Sheng-Li Wu, Taichung (TW)

Correspondence Address: Sheng-Li Wu, 58, MA YUAN WEST ST., TAICHUNG, TW

(21) Appl. No.: 10/436,410

(22) Filed: May 8, 2003

(51) Int. Cl. B05B 7/02; B05B 9/01

(52) U.S. Cl. 239/526

(57) ABSTRACT

A water sprayer includes a hollow body, a support seat, and a flow control device. The flow control device includes a push member, a sealing rubber, a press plate, a compression spring, a spring seat, a fixing nut, and a flow control knob. Thus, the water sprayer is provided with a flow control device, so that the water flow rate flowing from the water sprayer can be controlled optimally. In addition, the flow control knob of the flow control device is far away from the water outlet hole, thereby preventing the flow control knob from being wet.

### BACKGROUND OF THE INVENTION

1. Field of the Invention

The present invention relates to a water sprayer, and more particularly to a water sprayer having a flow control device.

2. Description of the Related Art

Usually, a conventional water sprayer is not provided with a flow control device, so that the water flow injected outward from the conventional water sprayer has a constant amount and cannot be adjusted to fit the user's practical requirement, thereby causing inconvenience to the user.

### SUMMARY OF THE INVENTION

The primary objective of the present invention is to provide a water sprayer that is provided with a flow control device, so that the water flow rate flowing from the water sprayer can be controlled optimally.

Another objective of the present invention is to provide a water sprayer, wherein the flow control knob of the flow control device is far away from the water outlet hole, thereby preventing the flow control knob from being wet.

A further objective of the present invention is to provide a water sprayer that can be operated easily and conveniently.

In accordance with the present invention, there is provided a water sprayer, comprising:

a hollow body having a first portion formed with a water inlet hole and a second portion formed with a water outlet hole communicating with the water inlet hole;

a support seat extended through the body and located between the water inlet hole and the water outlet hole, the support seat having a first portion formed with a first aperture communicating with the water inlet hole and a second aperture communicating with the water outlet hole; and

a flow control device mounted in the support seat and including a push member, a sealing rubber, a press plate, a compression spring, a spring seat, a fixing nut, and a flow control knob, wherein:

the push member of the flow control device has a first end formed with an operation post protruded outward from the support seat, and a second end formed with a stepped face and a combination post;

the spring seat of the flow control device is secured in the support seat and has a first side formed with a combination recess to receive the combination post of the push member, so that the combination post of the push member can slide and cannot be rotated in the combination recess of the spring seat;

the fixing nut of the flow control device is secured in the support seat, the fixing nut of the flow control device has a first side formed with a first through hole to receive the spring seat; and

the flow control knob of the flow control device is rotatably mounted on the fixing nut and is combined with the spring seat, so that the spring seat can be rotated by rotation of the flow control knob.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a water sprayer in accordance with the preferred embodiment of the present invention;

FIG. 2 is an exploded perspective view of the water sprayer in accordance with the preferred embodiment of the present invention;

FIG. 2A is a partially enlarged view of the water sprayer as shown in FIG. 2;

FIG. 2B is a partially enlarged view of the water sprayer as shown in FIG. 2;

FIG. 2C is a partially enlarged view of the water sprayer as shown in FIG. 2;

FIG. 3 is a side plan cross-sectional view of the water sprayer as shown in FIG. 1;

FIG. 3A is a cross-sectional view of the water sprayer taken along line 3A-3A as shown in FIG. 3;

FIG. 4 is a schematic operational view of the water sprayer as shown in FIG. 3 in adjustment;

FIG. 4A is a partially enlarged view of the water sprayer as shown in FIG. 4;

FIG. 4B is a partially enlarged view of the water sprayer as shown in FIG. 4;

FIG. 5 is a schematic operational view of the water sprayer as shown in FIG. 3 in adjustment;

FIG. 5A is a partially enlarged view of the water sprayer as shown in FIG. 5;

FIG. 5B is a partially enlarged view of the water sprayer as shown in FIG. 5; and

FIG. 6 is a schematic operational view of the water sprayer as shown in FIG. 3 in use.

### DETAILED DESCRIPTION OF THE INVENTION

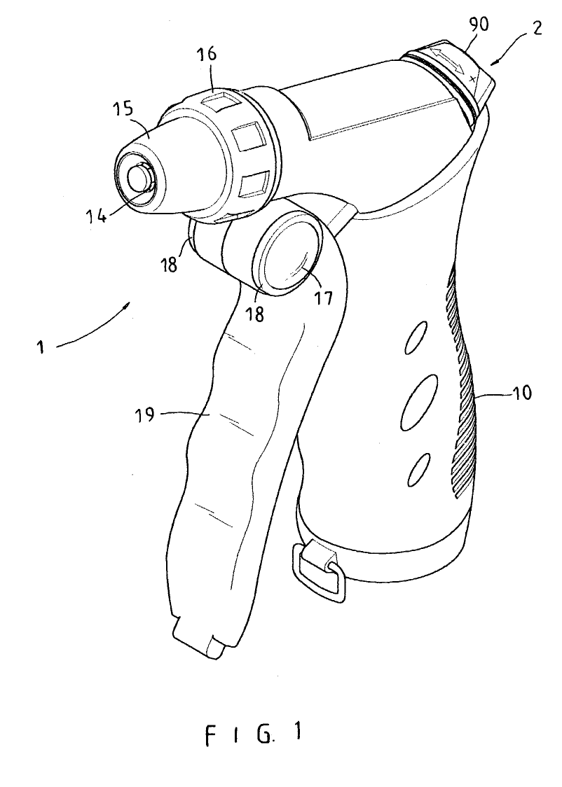

Referring to the drawings and initially to FIGS. 1-3, a water sprayer in accordance with the preferred embodiment of the present invention comprises a hollow body 10 having a first portion formed with a water inlet hole 12 and a second portion formed with a water outlet hole 11 communicating with the water inlet hole 12.

The water outlet hole 11 of the body 10 is provided with a water outlet seat 14, a water outlet cover 15, a water outlet cover rubber 16, and a plurality of seal rings 13. A press handle 19 is pivotally mounted on the body 10 by two handle caps 18 and a rivet 17.

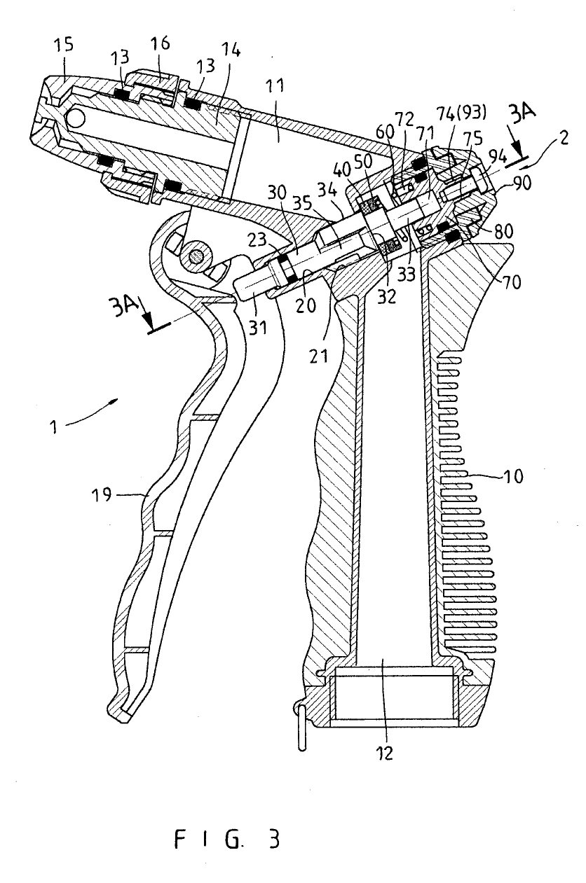

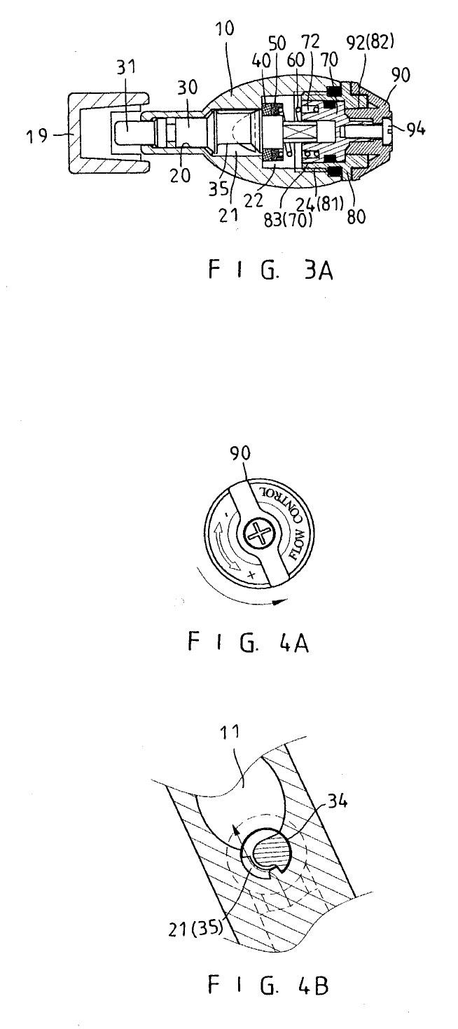

The water sprayer further comprises a support seat 20 extended through the body 10 and located between the water inlet hole 12 and the water outlet hole 11. The support seat 20 has a stepped shape and has a first portion formed with a first aperture 22 communicating with the water inlet hole 12 and a second aperture 21 communicating with the water outlet hole 11. The second aperture 21 has a diameter different from that of the first aperture 22 as shown in FIG. 3A.

The water sprayer further comprises a flow control device 2 mounted in the support seat 20 by a plurality of seal rings 23. The flow control device 2 includes a push member 30, a sealing rubber 40, a press plate 50, a compression spring 60, a spring seat 70, a fixing nut 80, and a flow control knob 90.

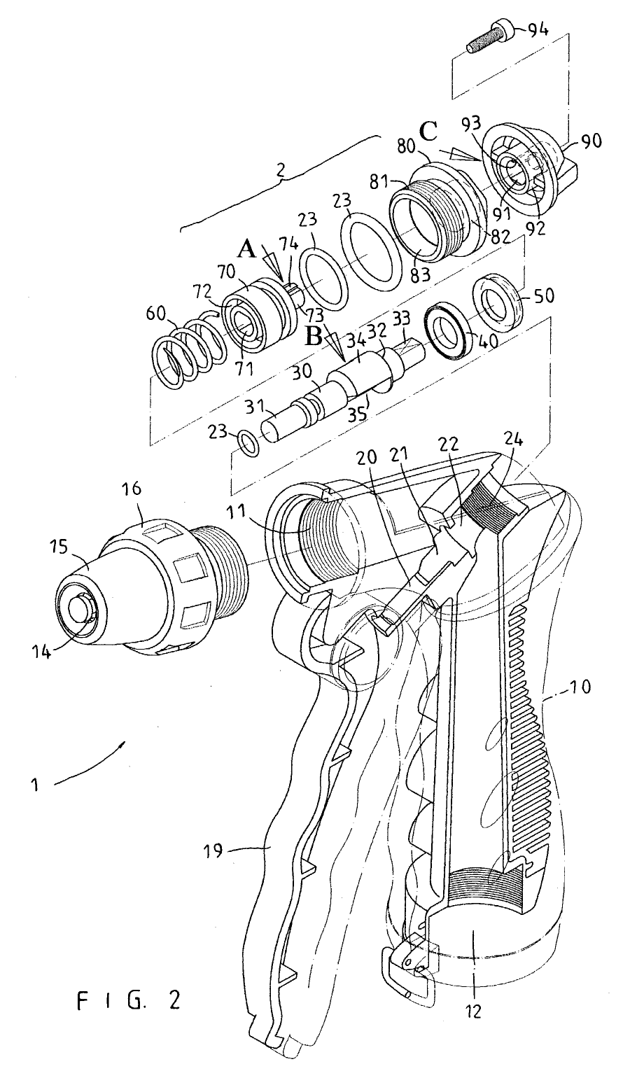

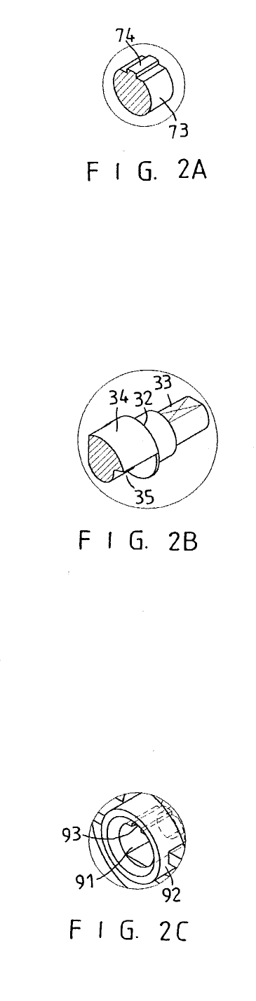

The push member 30 of the flow control device 2 is slidably mounted in the support seat 20 and has a first end formed with an operation post 31 protruded outward from the support seat 20 and rested on the press handle 19. In addition, under action of the water pressure in the body 10, the operation post 31 of the push member 30 is protruded outward from the support seat 20 and is urged on the press handle 19. The push member 30 of the flow control device 2 has a second end formed with a stepped face 32 and a non-circular combination post 33. The stepped face 32 of the push member 30 is flush with the second aperture 21 of the support seat 20. The push member 30 of the flow control device 2 has a mediate portion aligned with the second aperture 21 of the support seat 20 and formed with a closed face 34 and a sector-shaped cutout 35 (see FIG. 2B) located opposite to the closed face 34.

The sealing rubber 40, the press plate 50 and the compression spring 60 of the flow control device 2 are passed through the combination post 33 and are mounted on the stepped face 32 of the push member 30.

The spring seat 70 of the flow control device 2 is secured in the support seat 20 and has a first side having a center formed with a non-circular combination recess 71 to receive the combination post 33 of the push member 30, so that the combination post 33 of the push member 30 can slide and cannot be rotated in the combination recess 71 of the spring seat 70.

The compression spring 60 of the flow control device 2 has a first end urged on the first side of the spring seat 70 and a second end urged on the press plate 50, so that the sealing rubber 40 is pressed by the press plate 50 to seal the first aperture 22 of the support seat 20, and so that the water in the water inlet hole 12 cannot enter the second aperture 21 of the support seat 20 via the first aperture 22 of the support seat 20. Preferably, the first side of the spring seat 70 has a periphery formed with a spring groove 82 to receive the first end of the compression spring 60.

The fixing nut 80 of the flow control device 2 is secured in the support seat 20. Preferably, the support seat 20 is formed with an inner thread 24, and the fixing nut 80 of the flow control device 2 is formed with an outer thread 81 screwed into the inner thread 24 of the support seat 20, so that the fixing nut 80 of the flow control device 2 is secured in the support seat 20. The fixing nut 80 of the flow control device 2 has a first side formed with a first through hole 83 to receive the spring seat 70.

The flow control knob 90 of the flow control device 2 is rotatably mounted on the fixing nut 80 and is combined with the spring seat 70, so that the spring seat 70 can be rotated by rotation of the flow control knob 90. The flow control knob 90 of the flow control device 2 is located distal to the water outlet hole 11, thereby preventing the flow control knob 90 from being wet.

The fixing nut 80 of the flow control device 2 has a second side formed with a second through hole 82, and the flow control knob 90 of the flow control device 2 is provided with a bushing 92 rotatably mounted in the second through hole 82 of the fixing nut 80. The bushing 92 of the flow control knob 90 is formed with an axial hole 91, and the spring seat 70 of the flow control device 2 has a second side formed with a shaft 73 inserted into the axial hole 91 of the flow control knob 90.

In addition, the axial hole 91 of the flow control knob 90 has a periphery formed with a spline 93 (see FIG. 2C), and the shaft 73 of the spring seat 70 has a periphery formed with a key 74 (see FIG. 2A) locked in the spline 93 of the axial hole 91 of the flow control knob 90, so that the spring seat 70 can be rotated by rotation of the flow control knob 90.

In addition, the shaft 73 of the spring seat 70 has a center formed with a screw bore 75 (see FIG. 3), and the flow control device 2 further includes a locking screw 94 extended through the axial hole 91 of the flow control knob 90 and screwed into the screw bore 75 of the spring seat 70, so that the flow control knob 90 is combined with the spring seat 70.

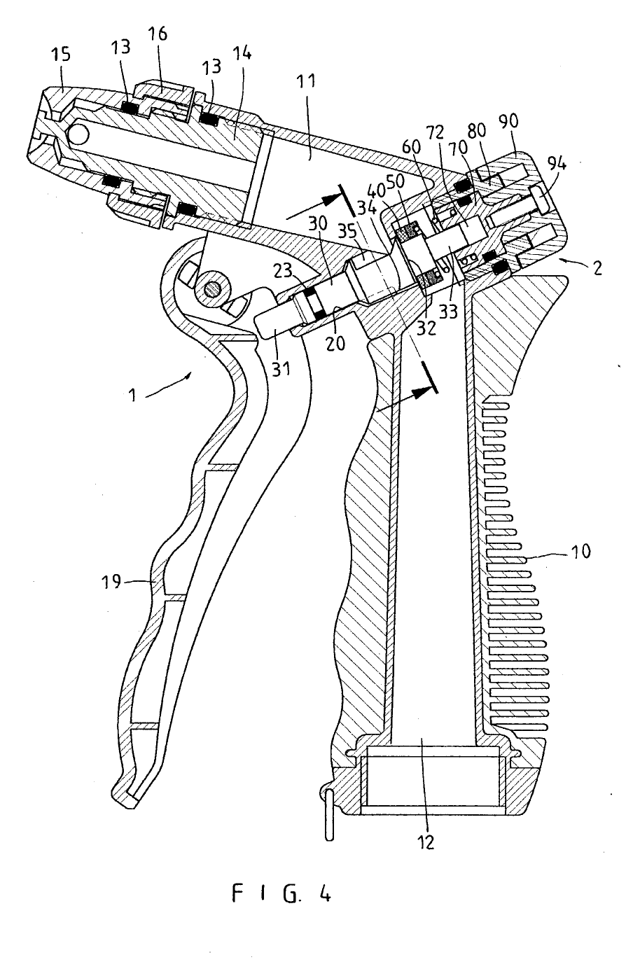

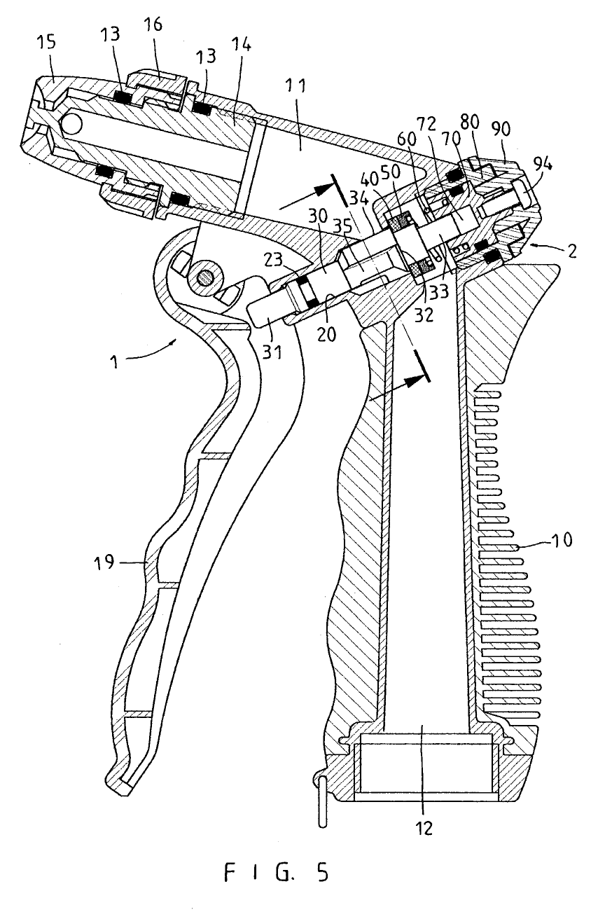

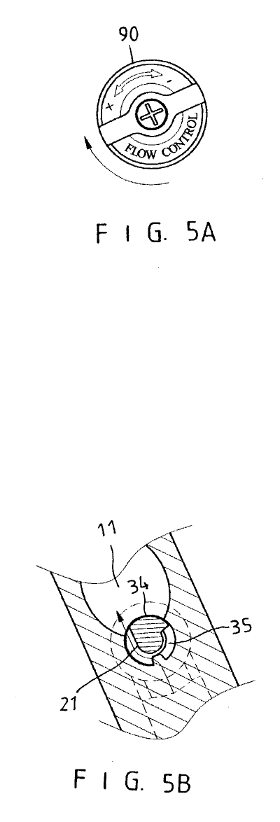

In operation, referring to FIGS. 4 and 5 with reference to FIGS. 1-3, when the flow control knob 90 is rotated, the spring seat 70 is also rotated to rotate the push member 30, so that the closed face 34 and the cutout 35 of the push member 30 can be rotated to align with the second aperture 21 of the support seat 20 respectively.

When the flow control knob 90 is rotated to the position as shown in FIG. 4A, the cutout 35 of the push member 30 can be rotated aligns with the second aperture 21 of the support seat 20 as shown in FIG. 4B, so that the water flow rate flowing from the second aperture 21 of the support seat 20 into the water outlet hole 11 is at the maximum state.

When the flow control knob 90 is rotated to the position as shown in FIG. 5A, the closed face 34 of the push member 30 can be rotated aligns with the second aperture 21 of the support seat 20 as shown in FIG. 5B, so that the water flow rate flowing from the second aperture 21 of the support seat 20 into the water outlet hole 11 is at the minimum state.

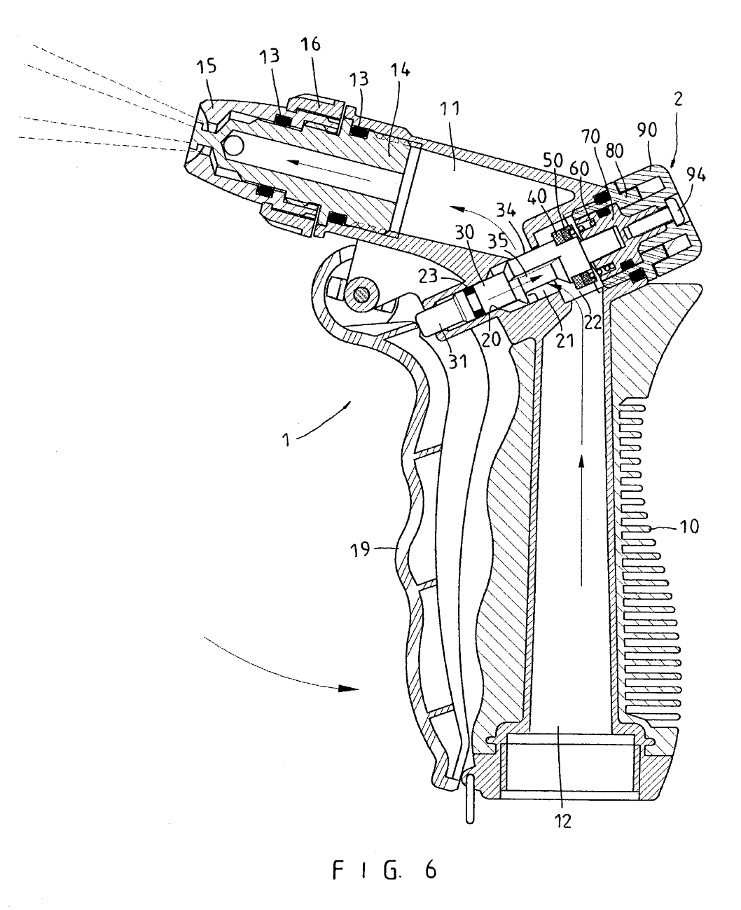

Referring to FIG. 6, when the press handle 19 is pressed toward the body 10, the operation post 31 of the push member 30 is pressed by the press handle 19, so that the push member 30 is moved into the support seat 20, and the stepped face 32 of the push member 30 is moved to push the sealing rubber 40, the press plate 50 and the compression spring 60, such that the water in the water inlet hole 12 can in turn flow through the first aperture 22 and the second aperture 21 into the water outlet hole 11, and can be injected outward from the water outlet hole 11.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A water sprayer, comprising:
a hollow body having a first portion formed with a water inlet hole and a second portion formed with a water outlet hole communicating with the water inlet hole;
a support seat extended through the body and located between the water inlet hole and the water outlet hole, the support seat having a first portion formed with a first aperture communicating with the water inlet hole and a second aperture communicating with the water outlet hole; and
a flow control device mounted in the support seat and including a push member, a sealing rubber, a press plate, a compression spring, a spring seat, a fixing nut, and a flow control knob, wherein:
the push member of the flow control device has a first end formed with an operation post protruded outward from the support seat, and a second end formed with a stepped face and a combination post;
the spring seat of the flow control device is secured in the support seat and has a first side formed with a combination recess to receive the combination post of the push member, so that the combination post of the push member can slide and cannot be rotated in the combination recess of the spring seat;
the fixing nut of the flow control device is secured in the support seat, the fixing nut of the flow control device has a first side formed with a first through hole to receive the spring seat; and
the flow control knob of the flow control device is rotatably mounted on the fixing nut and is combined with the spring seat, so that the spring seat can be rotated by rotation of the flow control knob.

2. The water sprayer in accordance with claim 1, wherein the second aperture has a diameter different from that of the first aperture.

3. The water sprayer in accordance with claim 1, wherein the flow control device is mounted in the support seat by a plurality of seal rings.

4. The water sprayer in accordance with claim 1, further comprising a press handle pivotally mounted on the body and rested on the operation post of the push member.

5. The water sprayer in accordance with claim 4, wherein the press handle is pivotally mounted on the body by two handle caps and a rivet.

6. The water sprayer in accordance with claim 1, wherein the push member of the flow control device is slidably mounted in the support seat.

7. The water sprayer in accordance with claim 1, wherein the stepped face of the push member is flush with the second aperture of the support seat.

8. The water sprayer in accordance with claim 1, wherein the push member of the flow control device has a mediate portion aligned with the second aperture of the support seat and formed with a closed face and a sector-shaped cutout located opposite to the closed face.

9. The water sprayer in accordance with claim 1, wherein the sealing rubber, the press plate and the compression spring of the flow control device are passed through the combination post and are mounted on the stepped face of the push member.

10. The water sprayer in accordance with claim 1, wherein the compression spring of the flow control device has a first end urged on the first side of the spring seat and a second end urged on the press plate, so that the sealing rubber is pressed by the press plate to seal the first aperture of the support seat, and so that the water in the water inlet hole cannot enter the second aperture of the support seat via the first aperture of the support seat.

11. The water sprayer in accordance with claim 10, wherein the first side of the spring seat has a periphery formed with a spring groove to receive the first end of the compression spring.

12. The water sprayer in accordance with claim 1, wherein the support seat is formed with an inner thread, and the fixing nut of the flow control device is formed with an outer thread screwed into the inner thread of the support seat, so that the fixing nut of the flow control device is secured in the support seat.

13. The water sprayer in accordance with claim 1, wherein the flow control knob of the flow control device is located distal to the water outlet hole.

14. The water sprayer in accordance with claim 1, wherein the fixing nut of the flow control device has a second side formed with a second through hole, and the flow control knob of the flow control device is provided with a bushing rotatably mounted in the second through hole of the fixing nut.

15. The water sprayer in accordance with claim 14, wherein the bushing of the flow control knob is formed with an axial hole, and the spring seat of the flow control device has a second side formed with a shaft inserted into the axial hole of the flow control knob.

16. The water sprayer in accordance with claim 15, wherein the axial hole of the flow control knob has a periphery formed with a spline, and the shaft of the spring seat has a periphery formed with a key locked in the spline of the axial hole of the flow control knob, so that the spring seat can be rotated by rotation of the flow control knob.

17. The water sprayer in accordance with claim 15, wherein the shaft of the spring seat has a center formed with a screw bore, and the flow control device further includes a locking screw extended through the axial hole of the flow control knob and screwed into the screw bore of the spring seat, so that the flow control knob is combined with the spring seat.
